(19) United States
(12) Patent Application Publication
(10) Pub. No.: US 2013/0280599 A1
(43) Pub. Date: Oct. 24, 2013

(54) ELECTRICITY STORAGE DEVICE

(71) Applicants: Kazuaki Matsumoto, Tokyo (JP); Kazuhiko Inoue, Tokyo (JP); Takehiro Noguchi, Tokyo (JP)

(72) Inventors: Kazuaki Matsumoto, Tokyo (JP); Kazuhiko Inoue, Tokyo (JP); Takehiro Noguchi, Tokyo (JP)

(73) Assignee: NEC CORPORATION, Tokyo (JP)

(21) Appl. No.: 13/976,702

(22) PCT Filed: Dec. 27, 2011
(86) PCT No.: PCT/JP2011/080150

§ 371 Date: Jun. 27, 2013

(30) Foreign Application Priority Data
Jan. 7, 2011 (JP) 2011-002199

(51) Int. Cl. H01M 4/66; H01M 10/04; H01M 10/0525; H01M 10/058; H01M 10/0568; H01M 4/04

(52) U.S. Cl. CPC H01M 4/667; H01M 10/0568; H01M 4/0402; H01M 10/0525; H01M 10/058; H01M 10/0413; H01M 10/0436
USPC 429/200; 429/211; 427/126.1

(57) ABSTRACT

Provided is an electricity storage device that is able to suppress the reaction between an electrolyte contained in an electrolyte solution and a current collector, corrosion of the current collector, deterioration of the electrolyte solution, and reduction in energy capacity, and that has high potential, excellent stability and durability, and is highly reliable. The electricity storage device has a positive electrode having a positive-electrode active material layer on a positive electrode current collector, a negative electrode having a negative-electrode active material layer on a negative electrode current collector, a separator, and an electrolyte solution. The positive electrode current collector and/or the negative electrode current collector has a corrosion suppression film on the surface thereof, and a thickness of the corrosion suppression film is 50 nm or more.

### TECHNICAL FIELD

The present invention relates to an electricity storage device that is able to suppress a reduction in electricity storage capacity and that has high stability and a method for manufacturing the same, and more particularly to an electricity storage device of a secondary battery such as a lithium ion secondary battery and a method for manufacturing the same.

### BACKGROUND

As the markets of vehicles such as hybrid or fuel cell vehicles and mobile devices such as notebook computer, mobile phone and the like are rapidly expanded, it is needed that an electricity storage device, for example a secondary battery and an electrochemical capacitor such as electric double layer capacitor or hybrid capacitor has high energy density, stability and reliability.

Such an electricity storage device has a positive electrode, a negative electrode and a separate intervened therebetween, as well as a cell tank that accommodates the electrodes and the separator and contains an electrolyte solution to immerse said components. For such an electricity storage device, energy is charged by an electrical double layer and/or a redox reaction and the charged energy is again discharged. Charge/discharge is repeatedly performed.

For such an electricity storage device, each of positive and negative electrodes is provided with an active material layer containing the corresponding active material and a current collector. The current collector is installed in contact with a surface of said active material layer to obtain electrical energy from the active material. As a method for forming the active material layer, a coating solution comprising an active material is firstly prepared, and then the solution is applied on a metal foil serving as a current collector to form the active material layer. Alternatively, an active material is pressed and rolled with a binding agent to obtain a sheet. The sheet is cut into an electrode shape, and the cut piece is pressed onto a metal foil serving as a current collector to form the active material layer. A region of the current collector that is not covered with the active material layer in an electricity storage device is exposed to an electrolyte solution. Therefore, the reaction between the current collector and an electrolyte and hence corrosion of the current collector and deterioration of the electrolyte solution are generated. As a result, a reduction in energy capacity for electricity storage is essentially caused.

To solve said problem, the current collector uses materials that are able to suppress reactions between the current collector and electrolytes. For example, for a secondary battery, materials such as aluminum are used, which can suppress the reaction with an electrolyte solution containing lithium fluorophosphate (LiPF₆) and the like as an electrolyte even at a positive electrode potential of 4.0V or more during a charging process.

Further, when lithium bistrifluoromethanesulfonylimide (hereinafter, it is also referred to as LITFSI) or lithium trifluoromethanesulfonate (hereinafter, it is also referred to as LiTFS) is used as an electrolyte of the electrolyte solution, advantageously these electrolytes exhibit high solubility in an organic solvent, good thermal stability and less generation of hydrogen fluoride during charge/discharge as compared with lithium fluorophosphate. However, it has been known that these electrolytes react with aluminum in the current collector at a positive electrode potential of 4.0V or more upon charging (Non-Patent document 1). Therefore, in fact, it is difficult to use said substances as an electrolyte.

To allow using LiTFS and the like mentioned above as solutes of an electrolyte solution used for a secondary battery, a non-aqueous electrolyte solution secondary battery has been known, in which an aluminum molded body having an AlF₃ film formed surface is used as a current collector to suppress the reaction between the current collector and LiTFS and the like (Patent document 1).

However, even though such an AlF₃ film is formed on an aluminum current collector, the reaction between the current collector and LiTFS cannot be sufficiently suppressed at high electrode potential. As a result, the current collector is increasingly corroded, and a reduction in battery capacity may be sufficiently suppressed.

The inventors have already developed a secondary battery that has an electrolyte solution containing LiTFS of 1.5 mol/L or more, exhibits excellent stability, and imparts flame resistance to the electrolyte solution (Patent document 2). This secondary battery contains a high concentration LiTFS and has high stability. There still remains a need for an electricity storage device that is able to suppress the corrosion of a current collector in an electrolyte solution containing a low concentration electrolyte and to select the current collector and the electrolyte in a wide variety of ranges.

### PRIOR ART DOCUMENTS

### Patent Document

Patent Document 1: JP Patent Application Publication No. Hei 6-231754

### Non-Patent Document

Non-Patent Document 1: Journal of Power Sources 68 (1997) 320-325

### SUMMARY OF THE INVENTION

### Problems to be Solved by the Invention

It is an object of the present invention to provide an electricity storage device that is able to suppress the reaction between an electrolyte contained in an electrolyte solution and a current collector, corrosion of the current collector, deterioration of the electrolyte solution, and reduction in energy capacity, and that has high potential, excellent stability and durability, and is highly reliable, as well as a method for manufacturing the same.

### Means to Solve the Problems

The present invention provides an electricity storage device having a positive electrode having a positive-electrode active material layer on a positive electrode current collector, a negative electrode having a negative-electrode active material layer on a negative electrode current collector, a separator, and an electrolyte solution, wherein the positive electrode current collector and/or the negative electrode current collector has a corrosion suppression film on the surface thereof, and a thickness of the corrosion suppression film is 50 nm or more.

### Effect of the Invention

An electricity storage device according to the present invention can suppress the reaction between an electrolyte contained in an electrolyte solution and a current collector, corrosion of the current collector, deterioration of the electrolyte solution, and reduction in energy capacity, and that has high potential, excellent stability and durability, and is highly reliable.

### BRIEF DESCRIPTION OF THE DRAWINGS

FIG. 1 is an exploded view showing the structure of a secondary battery as one example of an electricity storage device according to the present invention.

FIG. 2 is a diagram showing the discharge property of a secondary battery as one example of an electricity storage device according to the present invention.

FIG. 3 is an exploded view showing the structure of an electrical double layer capacitor as one example of an electricity storage device according to the present invention.

### DESCRIPTION OF EMBODIMENTS

According to the present invention, an electricity storage device has a positive electrode having a positive-electrode active material layer on a positive electrode current collector, a negative electrode having a negative-electrode active material layer on a negative electrode current collector, a separator, and an electrolyte solution, wherein the positive electrode current collector and/or the negative electrode current collector has a corrosion suppression film on the surface thereof, and the thickness of the corrosion suppression film is 50 nm or more.

As an embodiment of an electricity storage device according to the present invention, a secondary battery is exemplified in the following description.

### [Positive Electrode]

A positive electrode has a positive-electrode active material layer and a positive electrode current collector on which the positive-electrode active material layer is stacked.

The positive-electrode active material layer may contain any positive electrode active material, and preferably comprise a binding agent suitable for the positive electrode active material.

As such a positive-electrode active material, any material capable of absorbing and discharging lithium ions may be used. More particularly, examples include lithium manganates having a layered crystal structure such as LiMnO₂, LiₓMn₂O₄ (0<x<2), LiₓMn₁₅Ni_{0.5}O₄ (0<x<2) or lithium manganates having a spinel crystal structure; LiCoO₂, LiNiO₂ or the foregoing compounds in which transition metals are partially replaced by any one or two or more of Al, Fe, P, Ti, Si, Pb, Sn, In, Bi, Ag, Ba, Ca, Hg, Pd, Pt, Te, Zn, La; lithium transition metal oxides in which a certain transition metal constitutes less than a half of the whole structure such as LiNi_{1/3}Co_{1/3}Mn_{1/3}O₂; and the foregoing lithium transition metal oxides in which Li is used at an amount greater than stoichiometric amount. Particularly, it is preferred to use Li_{α}Ni_{β}Co_{γ}Al_{δ}O₂ (1≦α≦2, β+γδ=1, β≧0.7, γ≦0.2) or Li_{α}Ni_{β}Co_{γ}Mn_{δ}O₂ (1≦α≦1.2, β+γ+δ=1, β≧0.6, γ≦0.2). These positive-electrode active materials may be used alone or in any combination of two or more species.

As a binding agent for positive electrode, it is preferred to use materials that can bind positive-electrode active materials at a small amount, have stability to an electrolyte solution, and maintain the positive-electrode active materials integrated in a layer. More particularly, examples include polyfluorovinylidene, vinylidene fluoride-hexafluoropropylene copolymer, vinylidene fluoride-tetrafluoroethylene copolymer, styrene-butadiene copolymer rubber, polytetrafluoroethylene, polypropylene, polyethylene, polyimide, polyamideimide, polyacrylate or the like. Among these, it is preferred to use polyfluorovinylidene in terms of various utility and low costs. A content of the binding agent for positive electrode used is preferably in the range of 2-15 parts by weight with respect to 100 parts by weight of positive-electrode active material in terms of ‘sufficient adhesion’ and ‘high energy capacity’ which are traded off each other.

To increase the electric conductivity of current collector and positive-electrode active material, an electroconductive assisting agent may be added to the positive-electrode active material layer to reduce impedance. As such an electroconductive assisting agent, carbonaceous fine particles such as graphite, carbon black and acetylene black may be used.

A thickness of the positive-electrode active material layer containing the foregoing positive-electrode active materials is preferably between 140 and 180 μm. If the thickness of the positive-electrode active material layer is within said range, a volume that the layer occupies in a battery may not be significantly increased and a battery having high energy density may be obtained.

A thickness of the positive-electrode active material layer may be measured using stylus type thickness meter. Alternatively, when the layer is formed through vapor deposition, the thickness may be obtained from a change in weight of crystal resonator disposed within a deposition apparatus. In the following description, as the thickness of each layer, values measured by the same method may be used.

The positive electrode current collector holding the positive-electrode active material layer is preferably selected from materials which has excellent electronic conductivity, high adhesion to positive-electrode active materials, small volume and high density and is stable within a battery. Examples of these materials include aluminum, nickel, chromium, stainless, copper, silver or alloys containing any one of these metals. These materials may be used alone or in any combination of two or more species. The positive electrode current collector may have a shape such as a foil, a plate or a mesh.

A thickness of the positive electrode current collector may be between 10 and 30 μm. If the thickness of the positive-electrode current collector is within said range, a volume that the current collector occupies in a battery may not be significantly increased.

Said positive electrode current collector has preferably a corrosion suppression film having a thickness of 50 nm or more. The corrosion suppression film may be formed on the positive electrode current collector and/or a negative electrode current collector as described below, but it is preferred to form on the positive electrode current collector. The corrosion suppression film is made up in advance, and does not include oxide films formed on a surface in air or films on passive state metals formed during charge/discharge of a battery. That is, the corrosion suppression film includes films formed on a surface of current collector by physical or electrochemical methods such as vapor deposition, coating and sputtering.

The corrosion suppression film may be formed on the entire surface of the positive electrode current collector. Alternatively, the corrosion suppression film may be formed on regions except for a region where the positive-electrode active material layer is stacked. That is, the positive-electrode active material layer may be stacked on the positive electrode current collector without the corrosion suppression film, or may be stacked on the positive electrode current collector with the corrosion suppression film intervened. Further, the corrosion suppression film may be formed on the positive electrode active material layer. In this case, it is preferred that an increased interfacial resistance does not inhibit absorption and discharge of lithium ions in the positive electrode active material layer.

Said corrosion suppression film has a thickness of 50 nm or more, preferably 80 nm or more, and more preferably 100 nm or more. Also, the thickness of the corrosion suppression film may be equivalent to the thickness of the positive electrode active material layer, and in this case it is preferably 5 μm or less and more preferably 1 μm or less. If the thickness of the corrosion suppression film is within said range, the reaction between the positive electrode current collector and an electrolyte in an electrolyte solution may be suppressed and a reduction in production efficiency may be suppressed. Oxide films formed in air or films on passive state metals formed on a current collector during charge/discharge of a battery has often a thickness of 10 nm or less. However, the reaction between an electrolyte and a current collector cannot be sufficiently suppressed in 10 nm or less thickness. Also, when the corrosion suppression film is formed on the entire surface of the positive electrode current collector, a thickness of regions with a positive-electrode active material layer and a thickness of regions without the positive-electrode active material layer may be different each other.

Said corrosion suppression film is preferably formed from lithium compounds such as lithium fluoride or lithium carbonate, because reactions between these compounds and an electrolyte in an electrolyte solution may be effectively suppressed.

The corrosion suppression film may be formed using methods such as vapor deposition, sputtering or spin coating. Particularly, it is preferred to use a deposition method in terms of ease of operation. The corrosion suppression film may be formed on a surface of current collector before or after a positive electrode active material layer is formed on the current collector. More particularly, the corrosion suppression film is formed on the entire surface of the current collector, and subsequently the positive electrode active material layer may be formed. Alternatively, the positive electrode active material layer is stacked on a surface of the current collector, and subsequently the corrosion suppression film may be formed.

Also, when the corrosion suppression film is formed on a positive electrode current collector without a positive-electrode active material layer stacked, the positive-electrode active material layer is firstly formed on the positive electrode current collector. Afterward, the positive electrode active material layer is masked and the corrosion suppression film is formed using any one of the foregoing methods. Otherwise, the corrosion suppression layer is formed after masking a region on the positive electrode current collector where the positive-electrode active material layer will be staked. Afterward, the positive-electrode active material layer may be formed while masking a region where the corrosion suppression film is formed.

The positive electrode may be formed by applying a mixture of a positive-electrode active material and a binding agent with an electroconductive assisting agent or a solvent added as necessary on a positive electrode current collector using a doctor blade, die coater, or the like, or by pressing and rolling the mixture, punching a shape suitable for a positive electrode active material layer and pressing it on a positive electrode current collector. Also, the positive electrode may be made by forming a positive-electrode active material layer on a positive electrode current collector using a CVD or sputtering method, or by forming a positive electrode current collector on a pre-formed positive-electrode active material layer using a sputtering method or the like.

### [Negative Electrode]

A negative electrode has a negative-electrode active material layer and a negative electrode current collector on which the negative-electrode active material layer is stacked.

The negative-electrode active material layer may contain any negative electrode active material, and preferably comprise a binding agent suitable for binding the negative electrode active material and the negative electrode current collector.

As such a negative-electrode active material, any material capable of absorbing and discharging lithium ions may be used. More particularly, examples include carbonaceous materials such as carbon or graphite; metals such as Al, Fe, P, Ti, Si, Pb, Sn, In, Bi, Ag, Ba, Ca, Hg, Pd, Pt, Te, Zn, La, alloys containing said metals, or compounds such as oxides. These negative-electrode active materials may be used alone or in any combination of two or more species. Also, the negative-electrode active material may comprise one or two or more of other metals or non-metals, preferably tin or silicon oxides or carbonates.

As a binding agent for negative electrode, it is preferred to use materials that can bind negative-electrode active materials at a small amount, have stability to an electrolyte solution, and maintain the negative-electrode active materials integrated in a layer. More particularly, examples include those previously described for a binding agent for positive electrode. Likewise, it is preferred to use polyfluorovinylidene. A content of the binding agent for negative electrode used is preferably in the range of 5-25 parts by weight with respect to 100 parts by weight of negative-electrode active material in terms of ‘sufficient adhesion’ and ‘high energy capacity’ which are traded off each other.

To increase the electric conductivity of current collector and negative-electrode active material, an electroconductive assisting agent may be added to the negative-electrode active material layer. As such an electroconductive assisting agent, those exemplified in the positive-electrode active material layer may be similarly used.

A thickness of the negative-electrode active material layer containing the foregoing negative-electrode active materials is preferably between 100 and 140 μm. If the thickness of the negative-electrode active material layer is within said range, a volume that the layer occupies in a battery may not be significantly increased and a battery having high energy density may be obtained.

The negative electrode current collector holding the negative-electrode active material layer is preferably selected from materials which has excellent electronic conductivity, high adhesion to positive-electrode active materials, small volume and high density and is stable within a battery. Examples of these materials include those previously described for the positive electrode current collector. Also, the negative electrode current collector may have the same shape as the shape of the positive electrode current collector.

A thickness of the negative electrode current collector may be between 8 and 10 μm. If the thickness of the negative-electrode current collector is within said range, a volume that the current collector occupies in a battery may not be significantly increased.

As with the positive electrode current collector, said negative electrode current collector may have a corrosion suppression film having a thickness of 50 nm or more. The corrosion suppression film formed on the negative electrode current collector is made up in advance, and does not include oxide films formed on a surface in air or films on passive state metals formed during charge/discharge of a battery. Also, the corrosion suppression film formed on the negative electrode current collector may be formed on the entire surface of the positive electrode current collector, or may be formed on regions except for a region where the negative-electrode active material layer is stacked. That is, the negative-electrode active material layer may be stacked on the negative electrode current collector without the corrosion suppression film, or may be stacked on the negative electrode current collector with the corrosion suppression film intervened. Further, the corrosion suppression film may be formed on the negative electrode active material layer. In this case, it is preferred that an increased interfacial resistance does not inhibit absorption and discharge of lithium ions in the negative electrode active material layer.

As with the corrosion suppression film for the positive electrode current collector, the corrosion suppression film formed on the negative electrode current collector also has a thickness of 50 nm or more, preferably 80 nm or more, and more preferably 100 nm or more. Also, the thickness of the corrosion suppression film may be equivalent to the thickness of the negative electrode active material layer, and in this case it is preferably 5 μm or less and more preferably 1 μm or less. The corrosion suppression film for the negative electrode current collector may be formed using the same composition and method as those previously described for the corrosion suppression film formed on the positive electrode current collector.

As previously described for the positive electrode, the negative electrode also may be made by applying a solution containing a negative electrode active material on a negative electrode current collector, by pressing a piece containing a negative electrode active material pressed into a shape suitable for a negative electrode active material layer on a negative electrode current collector, by forming a negative electrode active material layer on a negative electrode current collector, or by forming a negative electrode current collector on a pre-formed negative electrode active material layer.

### [Electrolyte Solution]

The positive electrode and the negative electrode are immersed in an electrolyte solution. The electrolyte solution allows transferring charged species between the positive electrode and the negative electrode. Such an electrolyte solution is prepared by dissolving an electrolyte in an organic solvent. Examples of organic solvents include aliphatic carboxylic acid esters such as ethylene carbonate (EC), propylene carbonate (PC), butylene carbonate (BC), vinylene carbonate (VC), vinylethylene carbonate (VEC), ethylene sulfate (ES), propane sulfone (PS), butane sulfone (BS), dioxathiolane-2,2-dioxide (DD), sulforene, 3-methylesulforene, sulforane (SL), succinic anhydride (SUCAH), propionic anhydride, acetic anhydride, maleic anhydride, diallylcarbonate (DAC), diphenyldisulfide (DPS), dimethylcarbonate (DMC), ethylmethylcarbonate (EMC), chloroethylenecarbonate, diethylcarbonate (DEC), dimethoxyethane (DME), dimethoxymethane (DMM), diethoxyethane (DEE), ethoxymethoxyethane, dimethylether, methylethylether, methylpropylether, ethylpropylether, dipropylether, methylbutylether, diethylether, phenylmethylether, tetrahydrofuran (THF), tetrahydropyran (THP), 1,4-dioxane (DIOX), 1,3-dioxolane (DOL), acetonitrile, propionnitrile, γ-butyrolactone, γ-valerolactone, methyl formate, methyl acetate or ethyl propionate. In addition, to increase the flame retardancy of an electrolyte solution, trimethyl phosphate, triethyl phosphate, tripropyl phosphate, trioctyl phosphate, triphenyl phosphate, fluorinated ether having the structure Rᵥ₁—O—Rᵥ₂ (Rᵥ₁ and Rᵥ₂ is each independently an alkyl group or a fluoroalkyl group), ionic solution, phosphagen or the like may be mixed. These organic solvents may be used alone or in any combination of two or more species.

Among these, ethylene carbonate, diethyl carbonate, propylene carbonate, dimethyl cabonate, ethylmethyl carbonate, γ-butyrolactone, γ-valerolactone, trimethyl phosphate, triethyl phosphate, or the like are particularly preferred.

An electrolyte supporting salt contained in an electrolyte solution may include lithium salts such as LiPF₆, LiI, LiBr, LiCl, LiAsF₆, LiAlCl₄, LiClO₄, LiBF₄, LiSbF₆, LiCF₃SO₃ (Abbr.:LiTFS), LiC₄F₉SO₃, LiN(FSO₂)₂, LiN(C₂F₅SO₂)₂ (Abbr.:LiTFSI), LiN(C₂F₅SO₂)₂ (Abbr.:LiBETI), LiN(CF₃SO₂)(C₂F₅SO₂), LiN(CF₃SO₂)(C₄F₉SO₂), LiN(CF₂SO₂)₂(CF₂), LiN(CF₂SO₂)₂(CF₂)₂ wherein a 5-membered ring or 6-membered ring is contained, LiPF₅(CF₃), LiPF₅(C₂F₅), LiPF₅(C₃F₇), LiPF₄(CF₃)₂, LiPF₄(CF₃)(C₂F₅), LiPF₃(CF₃)₃ wherein at least one fluorine atom in LiPF₆ is substituted by fluoroalkyl groups, or the like.

Also, a sulfonyl compound represented by the following chemical formula (1) may be used as an electrolyte.

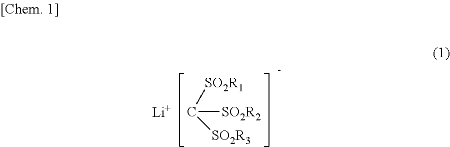

In the chemical formula (1), R₁, R₂ and R₃ are each independently a halogen atom, or a fluoroalkyl group. Examples of sulfonyl compounds represented by the formula (1) include LiC(CF₃SO₂)₃ and LiC(C₂F₅SO₂)₃.

These lithium salts or sulfonyl compounds may be used alone or in any combination of two or more species. Particularly, when an electrolyte solution using lithium trifluoromethane sulfonic acid (LiTFS) or lithium bistrifluoromethanesulfonylimide (LiTFSI) is used, the corrosion of a current collector can be significantly inhibited even in high potential such as 4.5V (vs Li/Li⁺).

A concentration of electrolyte in an organic solvent is preferably between 0.01 mol/L and 3 mol/L, and more preferably between 0.5 mol/L and 1.5 mol/L. If the concentration of electrolyte is within said range, a battery having improved safety, high reliability and reduced environmental load can be obtained.

### [Separator]

Any separator may be used as long as it suppresses a contact between the positive electrode and the negative electrode, transmits charged species, and is durable to the electrolyte solution. Examples of materials used for such a separator include polyolefine-based microporous membranes such as polypropylene or polyethylene, celluloses, polyethylene terephtalate, polyimide, polyamideimide, polyfluorovinylidene, polytetrafluoroethylene, or the like. These materials may be used in the form of a porous film, fabric, non-woven fabric, or the like.

A thickness of the separator may be for example 20 to 30 μm, since a volume that the separator occupies in a battery is not significantly increased.

### [Casing]

A casing has preferably strength sufficient to maintain stably the positive electrode, the negative electrode, the separator and the electrolyte solution described above, electrochemical stability to these components, and liquid-tight property. For example, for a layered laminate type secondary battery, laminate films formed from aluminum, silica-coated polypropylene, polyethylene or the like may be used as such a casing.

A shape of said secondary battery may be any one of cylindrical, planar winding rectangular, layered rectangular, coin, planar winding laminate or layered laminate.

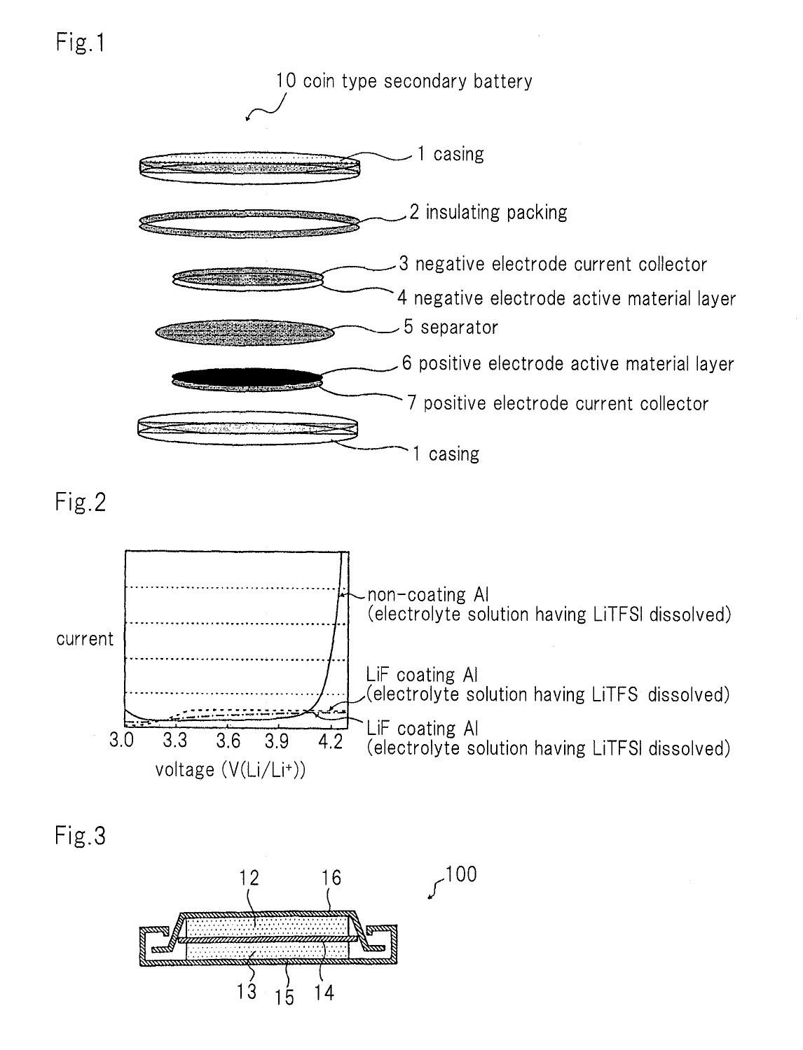

As an example of said secondary battery, a coin type secondary battery shown in the exploded view of FIG. 1 is exemplified. As shown in FIG. 1, a coin type secondary battery 10 has a negative electrode formed by stacking a negative electrode active material layer 4 on a negative electrode current collector 3, a positive electrode formed by stacking a positive electrode active material layer 6 on a positive electrode current collector 7, and a separator 5 intervened therebetween, and is accommodated within a casing 1 filling an electrolyte solution (not shown) with an insulating packing 2 intervened.

For said secondary battery, when a corrosion suppression film is formed on the current collectors, the corrosion of the current collectors is suppressed, and a reduction in energy capacity is also suppressed even in a high-energy capacity battery. A tri-electrode cell was prepared by using a LiF film having 200 nm thickness formed on an aluminum part of the positive electrode current collector that is not stacked with a positive electrode active material as a working electrode, lithium metal as a reference electrode and a counter electrode, and a solution of 1 mol/L LiTFSI or LiTFS in an organic solvent comprising EC:DEC at the ratio of 3:7 as an electrolyte solution. When this cell was subjected to sweeping from 3.0 to 4.3V (vs Li/Li⁺), a rapid current increase was not observed even in 4.3V voltage, as shown in FIG. 2. To the contrary, when a current collector without a LiF film and an electrolyte solution comprising 1 mol/L LiTFSI are used, a rapid current increase is observed around 4.0V (vs Li/Li⁺). From these observations, it is considered that a rapid current increase is caused due to the reaction between aluminum without a fluorolithium film on its surface and LiTFSI, and a fluorolithium film formed on aluminum current collector suppresses the reaction between the current collector and LiTFSI.

As an embodiment in which an electricity storage device according to the present invention is applied, an electrical double layer capacitor is exemplified.

As an example of said electrical double layer capacitor, an electrical double layer capacitor shown in the exploded view of FIG. 3 is exemplified. As shown in FIG. 3, an electrical double layer capacitor 100 has electrodes 12 and 14, and a separator 14 intervened between electrodes, and is accommodated within a casing 1 having a can 15 and a cap 16 together with an electrolyte solution (not shown). The can 15 and the cap 16 serve as a current collector for each electrode 12 and 13. The can 15 and the cap 16 have a corrosion suppression film (not shown) on their inner wall surface, which suppresses the reaction with a solvent or an electrolyte contained in the electrolyte solution.

The electrodes 12 and 13 may be formed using a mixture of activated carbon added with a lithium compound such as lithium oxide, an electroconductive agent such as carbon black and a binder such as polytetrafluoroethylene, polyfluorovinylidene or carboxymethylcellulose. The separator may be formed using the same material as that of the separator used in the secondary batter as previously described. Cellulose is preferably used.

Also, the can 15 and the cap 16 of the current collector may be used similarly to the secondary battery. Stainless steel is preferably used. As the corrosion suppression film on the current collector, a fluorolithium film may be used. This film is a film formed by vapor deposition or coating, not an oxide film formed in air or a film formed through electrochemical reactions in the capacitor. A thickness of this film is 50 nm or more, preferably 100 nm to 5 μm, and more preferably 1 μm or less.

Also, the electrolyte solution may use a solution containing the same organic solvent and electrolyte as those used in the secondary battery. Particularly, a 1 mol/L solution of LiTFSI, LiTFS or LiPF₆ in propylenecarbonate may be used.

This electrical double layer capacitor can suppress the reaction between the current collector and the electrolyte contained in the electrolyte solution, inhibits a reduction in energy capacity, and has excellent stability.

### EXAMPLES

Hereinafter, an electricity storage device according to the present invention will be described in detail.

### Example 1

### [Preparation of Positive Electrode]

To a lithium manganese composite oxide (LiMn₂O₄)-based material as an active material for positive electrode, VGCF (manufactured by SHOWA DENCO K.K.) was mixed as an electroconductive agent. The resulting mixture was dispersed in N-methylpyrrolidone (NMP) to form slurry. The slurry was applied on an aluminum foil as a positive electrode current collector, and dried to prepare an electrode having 12 mm diameter.

The aluminum current collector having a positive electrode active material layer formed thereon was installed within a deposition apparatus, the positive electrode active material layer was masked by a metal foil. A furnace filling lithium fluoride was heated while maintaining vacuum within the apparatus to form a film of lithium fluoride on a surface of the current collector that is not masked. The film formation was terminated based on a change in weight of crystal resonator disposed within the deposition apparatus, and a fluorolithium film of 100 nm thickness was obtained. As a result, a positive electrode having the current collector in which a part that is not stacked with the positive electrode active material layer is coated with a corrosion suppression film made of lithium fluoride was obtained.

### [Preparation of Negative Electrode]

A graphite-based material as an active material for negative electrode was dispersed in N-methylpyrrolidone (NMP) to form slurry. The slurry was applied on a copper foil as a negative electrode current collector, and dried to prepare an electrode having 12 mm diameter.

### [Preparation of Electrolyte Solution]

An electrolyte solution was prepared by dissolving 1 mol/L LiTFSI in an organic solvent of EC:DEC (30:70) in a dry room.

### [Preparation of Coin Type Secondary Battery]

The resulting positive electrode was placed on a stainless steel coin cell support serving as the current collector. A separator 4 formed from a porous polyethylene film and the resulting negative electrode were sequentially stacked to obtain a layered electrode body. The electrolyte solution obtained above was injected into the resulting layered electrode body to impregnate the layered electrode body in vacuum. The impregnation was sufficiently performed to fill voids in the separator and electrodes with the electrolyte solution. Then, an insulating packing was overlapped on the coin cell support serving as the current collector, and a stainless steel casing was integrally covered using a dedicated cocking device to prepare a coin type secondary battery as shown in FIG. 1. Prime discharge capacity was measured on the resulting coin type lithium secondary battery using the following method. The result is shown in Table 1.

### [Prime Discharge Capacity]

The obtained coin type lithium secondary battery was tested on prime discharge under upper limit potential 4.2V and lower limit potential 3.0V at 0.073 mA current. Prime discharge capacity was calculated by converting a discharge measurement into a value per unit weight of positive electrode active material.

### Example 2

A coin type lithium secondary battery was prepared by the same method as in Example 1 except that a fluorolithium film formed on the aluminum current collector of the positive electrode has 200 nm thickness, and prime discharge capacity was determined. The result is shown in Table 1.

### Example 3

A coin type lithium secondary battery was prepared by the same method as in Example 1 except that a fluorolithium film formed on the aluminum current collector of the positive electrode has 500 nm thickness, and prime discharge capacity was determined. The result is shown in Table 1.

### Example 4

A coin type lithium secondary battery was prepared by the same method as in Example 1 except that an electrolyte solution dissolving LiPF₆ instead of LiTFSI is used, and prime discharge capacity was determined. The result is shown in Table 1.

### Comparative Example 1

A coin type lithium secondary battery was prepared by the same method as in Example 1 except that a fluorolithium film is not formed on the aluminum current collector of the positive electrode, and prime discharge capacity was determined. The result is shown in Table 1.

### Comparative Example 2

A coin type lithium secondary battery was prepared by the same method as in Example 1 except that a fluorolithium film is not formed on the aluminum current collector of the positive electrode and an electrolyte solution dissolving LiPF₆ instead of LiTFSI is used, and prime discharge capacity was determined. The result is shown in Table 1.

TABLE 1

| | | | | | Prime |
|---|---|---|---|---|---|
| | Current collector | | | Sup- | discharge |
| | Film | Film | electrolyte | porting | capacity |
| | material | thickness | solution | salt (1M) | (mAh/g) |
| Example 1 | LiF | 100 nm | EC:DEC (3:7) | LiTFSI | 95 |
| Example 2 | LiF | 200 nm | EC:DEC (3:7) | LiTFSI | 103 |
| Example 3 | LiF | 500 nm | EC:DEC (3:7) | LiTFSI | 108 |
| Example 4 | LiF | 200 nm | EC:DEC (3:7) | LiPF₆ | 116 |
| Comp. | — | — | EC:DEC (3:7) | LiTFSI | 0 |
| Example 1 | | | | | |
| Comp. | — | — | EC:DEC (3:7) | LiPF₆ | 115 |
| Example 2 | | | | | |

When the aluminum current collector had no fluorolithium film and the electrolyte solution dissolving LiTFSI as a supporting salt was used, the prime discharge capacity was 0 mAh/g (Comparative example 1). This battery was not operated as a battery. It is appeared that the reason is that the battery cannot be charged due to oxidation reaction between LiTFSI and aluminum. To the contrary, when the aluminum current collector had a fluorolithium film and LiTFSI was used as a supporting salt, the prime discharge capacity was obtained. It is appeared that the reason is that the fluorolithium film acts as a corrosion suppression film to suppress the reaction between the current collector and the supporting salt.

Also, when LiPF₆ was used as a supporting salt and the aluminum current collector having a fluorolithium film was used, the prime discharge capacity was increased (Example 4, Comparative example 2). It is appeared that the reason also is that the fluorolithium film suppresses the reaction between LiPF₆ and the aluminum current collector, as is LiTFSI used.

According to the present invention, a corrosion suppression film formed on a current collector suppresses the reaction between the current collector and an electrolyte contained in an electrolyte solution. Therefore, options for selecting an electrolyte solution containing an electrolyte and a current collector may be expanded, and a condition for designing an electricity storage device may be simplified.

The present invention incorporates all descriptions of the specification, claims and drawings firstly attached to JP Patent Application No. 2011-2199.

### INDUSTRIAL APPLICABILITY

The present invention can be used in all industrial areas for which electric power is necessary, and any industrial area to which the transfer, storage and supply of electric energy is related. Particularly, the present invention can be used as power for mobile devices such as mobile phones, notebook computers or the like; power for motor vehicles such as electric cars, hybrid cars, electric powered bikes, electric powered bicycles or the like; power for travel/transfer means such as trains, satellites, submarines or the like; power for backup of UPS or the like; power storage facilities for storing electric power generated by solar photovoltaic generation, wind power generation or the like; or the like.

### DESCRIPTION OF REFERENCE NUMBERS

1 casing
3 negative electrode current collector
4 negative electrode active material layer
5 separator
6 positive electrode active material layer
7 positive electrode current collector
10 coin type secondary battery

1. An electricity storage device comprising a positive electrode having a positive electrode active material layer on a positive electrode current collector, a negative electrode having a negative electrode active material layer on a negative electrode current collector, a separator, and an electrolyte solution, wherein the positive electrode current collector, or the negative electrode current collector, or both has a corrosion suppression film on the surface thereof, and a thickness of the corrosion suppression film is 50 nm or more.

2. The electricity storage device of claim 1, wherein the corrosion suppression film is a film formed by vapor deposition.

3. The electricity storage device of claim 1, wherein the corrosion suppression film contains lithium fluoride.

4. The electricity storage device of claim 1, wherein the positive electrode current collector, or the negative electrode current collector, or both contains one or two or more species selected from aluminum, nickel, chromium, stainless, copper, silver, and alloys comprising any one of these metals.

5. The electricity storage device of claim 1, wherein the electrolyte solution contains one or two species selected from lithium salts consisting of lithium bistrifluoromethanesulfonylimide and lithium trifluoromethanesulfonate.

6. The electricity storage device of claim 1, wherein the electrolyte solution contains a lithium salt dissolved at a concentration in the range of 0.01 mol/L to 3 mol/L.

7. A method of manufacturing an electricity storage device comprising forming a corrosion suppression film by vapor deposition of a lithium salt onto a current collector.

8. The method of manufacturing an electricity storage device of claim 7, wherein the corrosion suppression film is formed onto a region of the current collector that is not covered by an active material layer.
